(19) United States
(12) Patent Application Publication
(10) Pub. No.: US 2020/0200665 A1
(43) Pub. Date: Jun. 25, 2020

(54) SYSTEMS AND METHODS FOR ASSESSING SUSPENDED PARTICLE SETTLING

(71) Applicant: BP Corporation North America Inc., Houston, TX (US)

(72) Inventors: Steven John TINKER, Houston, TX (US); Troy Matthew DECKER, Houston, TX (US)

(73) Assignee: BP Corporation North America Inc., Houston, TX (US)

(21) Appl. No.: 16/722,453

(22) Filed: Dec. 20, 2019

Related U.S. Application Data
(60) Provisional application No. 62/783,789, filed on Dec. 21, 2018.

(51) Int. Cl. G01N 15/04; G01N 1/38

(52) U.S. Cl. CPC G01N 15/04; G01N 1/38

(57) ABSTRACT

A method for determining a rate at which solid particles settle from a liquid in a slurry includes (a) mixing the solid particles and the liquid to form the slurry. In addition, the method includes (b) placing the slurry in an inner cavity of a vessel. Further, the method includes (c) measuring a hydrostatic pressure of the slurry at a bottom of the inner cavity over a period of time after (b). The method also includes (d) determining a quantity of the solid particles that settle from the liquid as a function of time over the period of time using the hydrostatic pressure measurements from (c).

### CROSS-REFERENCE TO RELATED APPLICATIONS

This application claims priority to U.S. Provisional patent application No. 62/783,789, filed with the U.S. Patent and Trademark Office on Dec. 21, 2018 and entitled “Systems and Methods for Assessing Suspended Particle Settling,” the disclosure of which is incorporated herein by reference in its entirety.

### BACKGROUND

This disclosure relates generally to systems and methods for assessing the settling of solid particles suspended in a liquid. More particularly, this disclosure relates to systems and methods for determining the rate at which solid particles suspended in a liquid settle out of a liquid as a function of time.

To obtain hydrocarbons from a subterranean formation, a borehole is drilled from the surface to access the hydrocarbon-bearing reservoir within the formation. After drilling the borehole to the desired location, completion operations are performed to prepare the borehole for production. In particular, a portion of the open borehole extending from the surface is lined with casing, which is secured in place by cement. Fluid communication between a production zone of the reservoir and the inside of the casing may be provided by perforating the casing and/or installing a screen along the portion of the borehole adjacent the production zone. To limit and control the free migration of formation sand from the reservoir through the perforated casing and/or screen, a gravel pack may be installed in the annulus between the borehole sidewall (along the production zone) and the casing and/or screen. More specifically, in an “open hole gravel pack,” perforated casing is not provided, and thus, the gravel pack is installed in the borehole between the borehole sidewall and the screen. Alternatively, in a “cased hole gravel pack,” perforated casing is provided and the screen is positioned within the perforated casing. Thus, a cased hole gravel pack is installed in an annular space between the perforated casing and the screen.

The gravel pack comprises a pack of properly sized proppant or gravel (e.g., sand or other solid particulate matter), and functions as a filter to limit and/or prevent formation sand from passing into the casing during production operations while simultaneously allowing production fluids (e.g., hydrocarbon liquids and gases) to pass into the casing during production operations.

### BRIEF SUMMARY OF THE DISCLOSURE

Embodiments of methods for determining a rate at which solid particles settle from a liquid in a slurry are disclosed herein. In one embodiment, a method for determining a rate at which solid particles settle from a liquid in a slurry comprises (a) mixing the solid particles and the liquid to form the slurry. In addition, the method comprises (b) placing the slurry in an inner cavity of a vessel. Further, the method comprises (c) measuring a hydrostatic pressure of the slurry at a bottom of the inner cavity over a period of time after (b). The method also comprises (d) determining a quantity of the solid particles that settle from the liquid as a function of time over the period of time using the hydrostatic pressure measurements from (c).

Embodiments of apparatus for determining a settling rate of solid particles mixed with a liquid in a slurry are disclosed herein. In one embodiment, an apparatus for determining a settling rate of solid particles mixed with a liquid in a slurry comprises a vessel having an inner cavity configured to receive and hold the slurry. The inner cavity has a bottom. In addition, the apparatus comprises a first pressure transducer coupled to the vessel and configured to measure a hydrostatic pressure of the slurry in the inner cavity at a first location adjacent the bottom of the inner cavity.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various exemplary embodiments, reference will now be made to the accompanying drawings in which:

FIG. 1 is a schematic view of a completion system for a subterranean wellbore;

FIGS. 2-4 are sequential schematic views of a gravel pack completion utilizing the completion system of FIG. 1 according to some embodiments;

FIG. 5 is a schematic side view of an embodiment of a test apparatus for determining the quantity and rate at which a proppant settles out of a slurry;

FIGS. 6-8 are sequential schematic side views of an exemplary test to determine the settling rate of proppant in a slurry using the apparatus of FIG. 5;

FIG. 9 is a graphical illustration of the pressures measured by each pressure transducer of the apparatus of FIG. 5 during the test shown in FIGS. 6-8 as a function of time;

FIG. 10 is a graphical illustration of the height of the of the proppant that settled during the test shown in FIGS. 6-8 as a function of time;

FIG. 11 is a graphical illustration of the percent of proppant that settled during the test shown in FIGS. 6-8 as a function of time; and

FIG. 12 is a schematic side view of an embodiment of a test apparatus for determining the quantity and rate at which a proppant settles out of a slurry.

### DETAILED DESCRIPTION OF EXEMPLARY EMBODIMENTS

The following discussion is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct engagement between the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. Any reference to up or down in the description and the claims is made for purposes of clarity, with “up”, “upper”, “upwardly”, “uphole”, or “upstream” meaning toward the surface of the borehole and with “down”, “lower”, “downwardly”, “downhole”, or “downstream” meaning toward the terminal end of the borehole, regardless of the borehole orientation. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

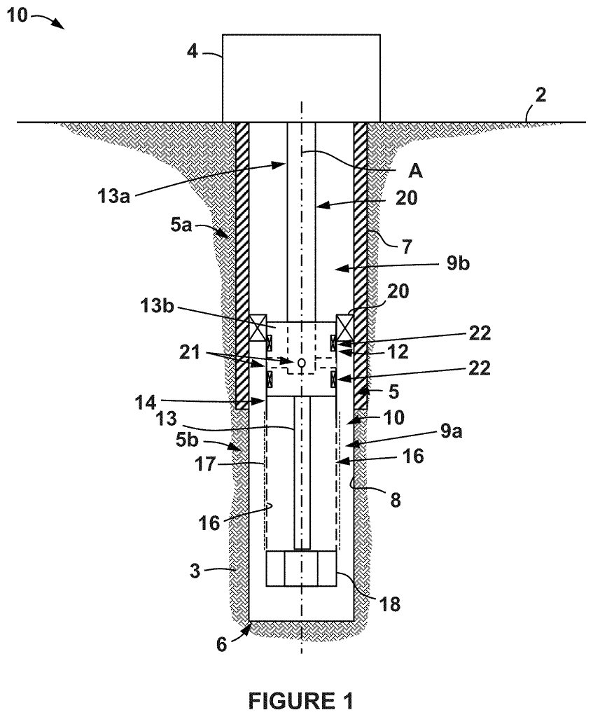

As previously described, gravel packs can be installed during a completion operation to limit and/or prevent the production of formation sand during production operations. For instance, referring now to FIG. 1, an embodiment of a completion system 10 for installing a gravel pack is shown. Although FIG. 1 illustrates an completion system 10 for installing a gravel pack in an open hole, embodiments described herein can also be used in connection with cased hole gravel packs.

Completion system 10 is disposed within a borehole 5 drilled through a subterranean formation 3. Borehole 5 has a central or longitudinal axis A. In this embodiment, borehole 5 includes a first or cased section 5a extending from the surface 2, and a second or uncased section 5b extending from cased section 5a to a distal or downhole end 6. Cased section 5a is lined with a casing 7, which is secured within section 5a of borehole 5 with cement disposed radially between casing 7 and the sidewall 8 of borehole 5. Uncased section 5b does not include a casing or liner pipe so that sidewall 8 is exposed.

System 10 extends axially through borehole 5 and includes a screen assembly 12, a work string 13a extending from the surface 2, a gravel pack service tool 13b mounted to the lower end of work string 13a, and a wash pipe 13 extending from service tool 13b. Service tool 13b and wash pipe 13 can be lowered and positioned as desired within borehole 5 and screen assembly 12 via work string 13a. In this embodiment, screen assembly 12 includes a blank pipe 14, a base pipe 16 extending from blank pipe 14 to a washdown shoe 18, and a screen 17 disposed about the base pipe 16. Base pipe 16 can be coupled to or integral with blank pipe 14. Base pipe 16 is a tubular member including a plurality of perforations extending radially therethrough. Screen 17 is disposed about base pipe 16 and includes a plurality of holes extending radially therethrough. The holes in screen 17 are smaller than the perforations in base pipe 16. As will be described in more detail, the holes in screen 17 and the perforations in base pipe 16 allow liquids (e.g., production fluids and liquids in a gravel pack slurry) to pass therethrough, however, the holes in screen 17 restrict and/or prevent sand produced from formation 3 from passing therethrough.

Referring still to FIG. 1, work string 13a is a tubular string that may comprise a plurality of tubular members coupled together end-to-end (e.g., threaded) and suspended from the surface 2. Service tool 13b is positioned in pipe 14 downhole of packer 20. Service tool 13b includes annular seals 22 that move therewith and sealingly engage pipe 14. Service tool 13b includes one or more crossover ports 21 for supplying a gravel pack slurry (e.g., slurry 30 described in more detail below) from work string 13a to the annular region disposed about service tool 13b.

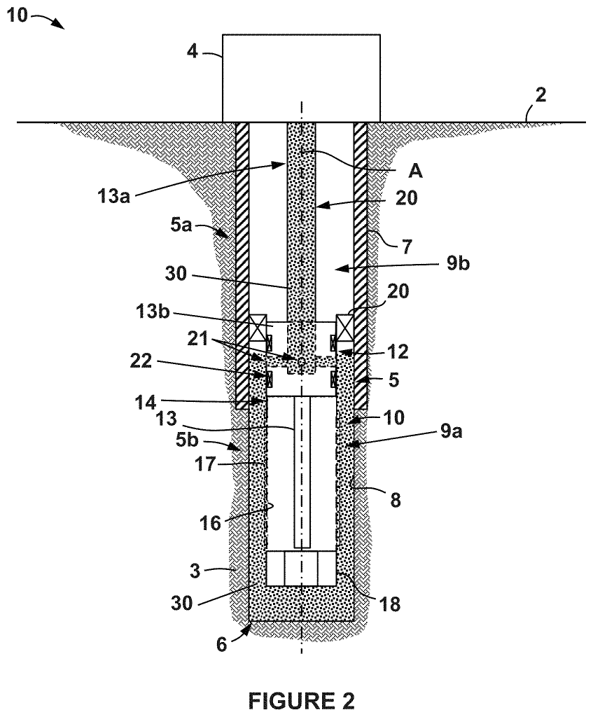

FIGS. 2-4 illustrate the installation of a gravel pack 35 with completion system 10. Prior to installing gravel pack 35, one or more samples of the formation 3 are obtained and analyzed using to determine the size and distribution of the formation sand (e.g., median grain size and grain size distribution). Based on the evaluation of the formation sand, the size and quality of the proppant or gravel for the gravel pack 35 are determined using techniques known in the art. Next, the proppant or gravel having the predetermined size and quality are mixed into a liquid to form a slurry 30, which is a suspension comprising the solid particles of proppant or gravel suspended within the liquid. For purposes of clarity and further explanation, the proppant, gravel, sand or other solid particulate matter that is suspended in a liquid to form a slurry, which is supplied downhole to form a gravel pack or other sand control structure downhole may generally be referred to herein as “proppant.” In general, the proppant used to form the slurry 30 can comprise any solid particulate material known in the art for forming a gravel pack or other sand control structure including, without limitation, sand, treated sand, man-made ceramic material, or combinations thereof; and the liquid within which the proppant is suspended to form the slurry 30 may comprise any sand control fluid known in the art including, without limitation, a polymer gel, a viscoelastic surfactant, Xanthan, brine, a cross-linked borate fluid, cross-linked gel, diesel, oil, foam, or combinations thereof.

Referring now to FIG. 2, to install gravel pack 35, completion system 10 is inserted into borehole 5. Screen assembly 12 may be inserted either by work string 13a (e.g., by coupling screen assembly 12 to work string 13a at surface 2 and lowering the coupled work string 13a and screen assembly 12 downhole) or screen assembly 12 may be installed within borehole 5 prior to inserting work string 13a therein. In either case, screen assembly 12 is secured within borehole 5, particularly within uncased section 5b and a packer or seal element 20 is installed radially between blank pipe 14 and casing pipe 7. Packer 20 prevents (or restricts) fluid flow between a first annulus 9a radially positioned between screen assembly 12 and sidewall 8 below packer 20 (along uncased section 5b of borehole 5) and a second annulus 9b radially positioned between tool string 13a and casing 7 above packer 20 (along cased section 5a of borehole 5) during completion operations.

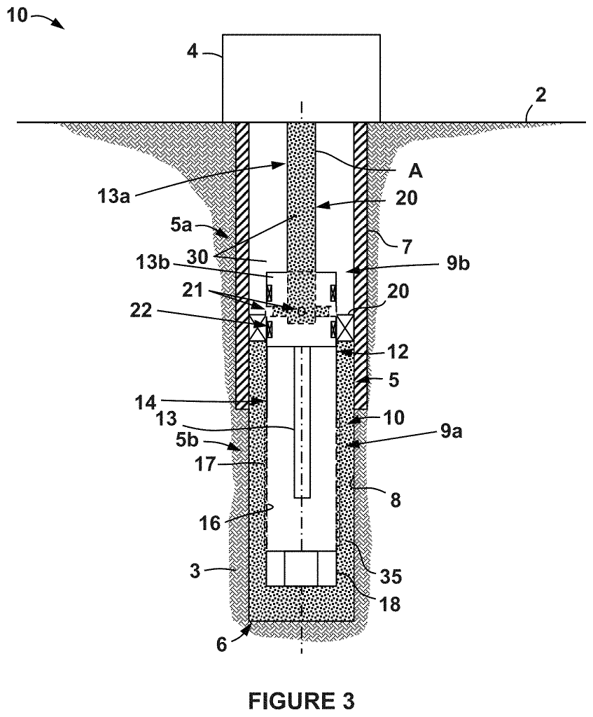

With screen assembly 12 and packer 20 in place within borehole 5, the slurry 30 is prepared at the surface as described above and pumped or flowed downhole via the work string pipe 13a. The slurry 30 passes from work string 13a into service tool 13b, and then exits service tool 13b via crossover ports 21 and passes into first annulus 9a between screen assembly 12 and sidewall 8 (below packer 20). Packer 20 prevents (or at least restricts) the flow of fluids (e.g., slurry 30) uphole between first annulus 9a below packer 20 and second annulus 9b above packer 20. Thus, upon exiting crossover ports 21, the slurry 30 flows downhole through first annulus 9a to end 6 of borehole 5, thereby filling first annulus 9a within uncased section 5b. The liquid of the slurry 30 may flow radially inward from first annulus 9a into base pipe 16 via the holes in screen 17 and perforations in base pipe 16. The liquid of slurry 30 within base pipe 16 passes through washpipe 13 and ports within service too 13b into second annulus 9b above the packer 20. The proppant in the slurry 30 and the holes in screen 17 are sized such that the proppant cannot pass through the screen 17, and thus, the proppant remains in the first annulus 9a to form the gravel pack 35 as shown in FIG. 3.

Any slurry 30 remaining within the work string 13a following installation of the gravel pack 35 can be reverse circulated out of the work string 13a by shifting the service tool 13b upward to position the crossover ports 21 above the packer 20, and then circulating a fluid down first annulus 9a into crossover ports 21, through service tool 13b, and back up workstring 13a as shown in FIG. 3.

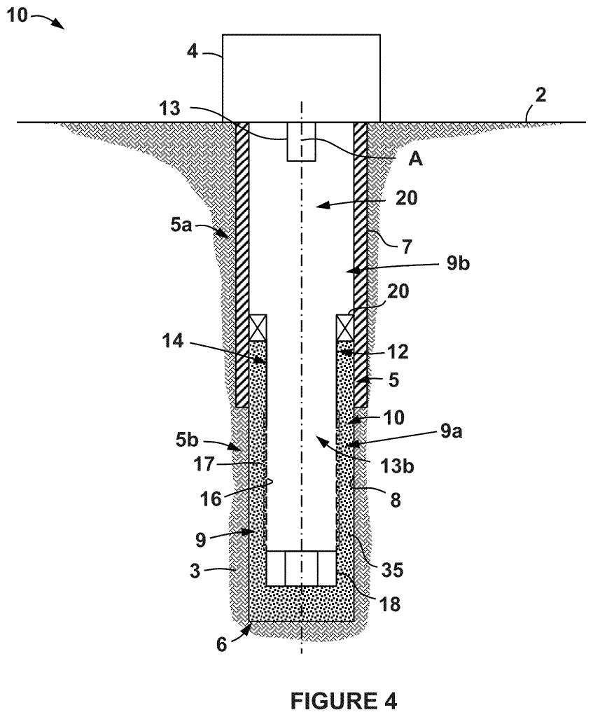

Referring now to FIG. 4, following the installation of gravel pack 35, the work string pipe 13a is withdrawn or tripped to surface 2 by surface equipment 4, thereby leaving screen assembly 12 and gravel pack 35 installed within borehole 5. As previously described above, the proppant within gravel pack 35 is configured to filter out some or all of the formation sand that may be produced from formation 3 along with formation fluids so that only (or substantially only) formation fluids (e.g., oil, gas, water, condensate, etc.) pass through first annulus 9a, screen 17, and base pipe 16, and are ultimately produced to the surface 2. Because the above described gravel pack completion of FIGS. 2-4 is performed within an uncased section 5b of borehole 5, so that gravel pack 35 is disposed in the first annulus 9a between sidewall 8 and screen 17, this completion operation may be referred to as an open hole gravel pack completion. However, as previously described, embodiments described herein (e.g., system 10) can also be used to install a gravel pack (e.g., gravel pack 35) in a cased section of a borehole (e.g., case section 5a).

As previously described and shown in FIG. 2, the slurry 30 is pumped from the surface 2 down the work string 13a, through the gravel pack service tool 13b and associated crossover ports 21 into first annulus 9a. As the slurry 30 flows from the surface 2 to the first annulus 9a, and while the slurry 30 is positioned at the desired location in the first annulus 9a, the proppant in the slurry 30 may settle out of the liquid under the force of gravity. If a sufficient quantity of the proppant settles out of the slurry 30, and thus, fails to reach the desired location in the first annulus 9a or migrates out of the desired location in the first annulus 9a, the resulting gravel pack 35 may not function properly. For example, if an insufficient quantity of the proppant is provided in the gavel pack 35, the gravel pack 35 may allow an undesirable quantity of formation sand to pass therethrough during subsequent production operations. Accordingly, it is advantageous to understand the behavior of the slurry (e.g., slurry 30) during installation of the gravel pack (e.g., gravel pack 35), and in particular, the rate at which the proppant in the slurry settles out of the slurry as such information may provide insight as to the properties of the liquid and the proppant that make up the slurry at the surface that are necessary to achieve the desired quantity of proppant in the installed gravel pack.

The conventional approach to estimating the settling rate of proppant or gravel in a slurry relies on visual estimations of settling over time. In particular, a known volume of a liquid and a known quantity of proppant are mixed at a known proppant concentration (e.g., lbs of proppant per gallon of liquid) to form a slurry. The slurry is them placed in a graduated cylinder for a period of time. The slurry in the cylinder is observed at periodic intervals over the period of time to measure the volume of clear liquid with no proppant at the top of the graduated cylinder. The amount or percentage of proppant that has settled for each observation is the volume of clear liquid with no proppant divided by the total volume of the liquid used in the slurry. For example, if 5 ml of clear liquid is observed in the slurry containing a total of 100 ml of liquid, it is estimated that 5 vol % of the proppant has settled. Observations are continued until either (i) the proppant has completely settled, or more commonly in viscous fluids with long settling times, or (ii) a predetermined percentage such as 10 vol % to 20 vol % has settled. Many slurries are cloudy and lack a clear distinct boundary between the settled particles and the suspended particles. Consequently, settling rates estimated in the conventional manner described above may be inconsistent or inaccurate. Accordingly, embodiments disclosed herein include systems and methods for determining settling rates of solid particulate matter such as proppant or gravel in a slurry that offer the potential to enhance accuracy as compared to the conventional approach to estimating settling rates. In particular, embodiments disclosed herein rely on direct pressure measurements of a slurry sample in a test vessel to determine the amount (e.g, weight, height, or volume of the proppant or gravel) and rate (e.g., percent of the proppant or gravel by weight or volume that settles as a function of time) of settling of the proppant or gravel in the slurry over time.

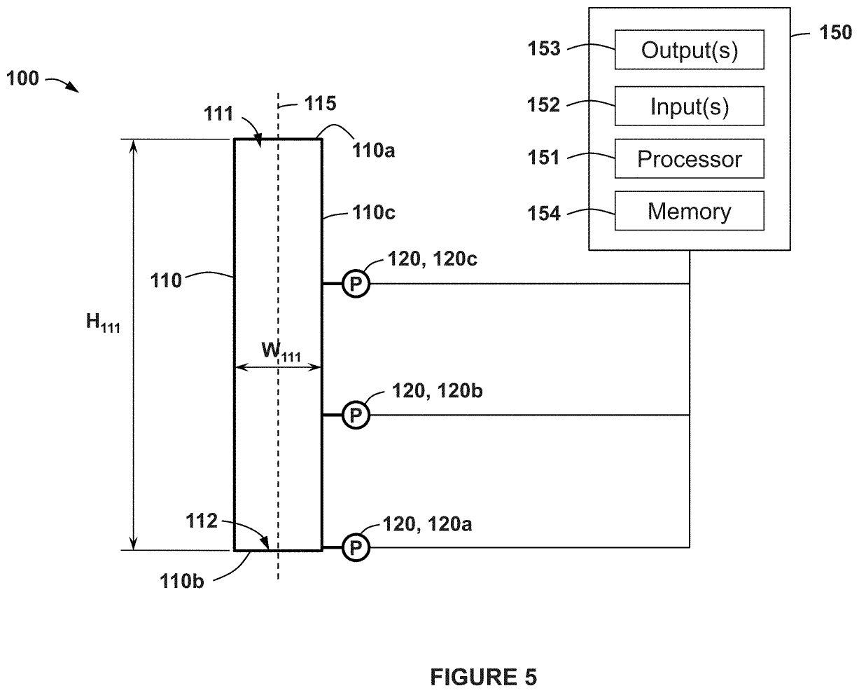

Referring now to FIG. 5, an embodiment of a test apparatus 100 for determining the quantity and rate at which a proppant settles out of a slurry is shown. In general, test apparatus 100 can be used in a lab and/or in the field. In addition, the slurry evaluated with test apparatus 100 can be used to form a gravel pack as previously described (e.g., slurry 30 used to form gravel pack 35) or any other type of proppant-based structure delivered downhole via a slurry and installed downhole to limit and/or control the production of formation sand.

In this embodiment, test apparatus 100 includes a test vessel 110, a plurality of vertically spaced pressure sensors or transducers 120 coupled to vessel 110, and a computing device 130 communicatively coupled to each pressure transducer 120. Vessel 110 is a container for holding the slurry to be tested and evaluated. In this embodiment, vessel 110 is an elongate, vertically oriented cylindrical container having a vertically oriented central or longitudinal axis 115, an open upper end 110a for receiving the slurry, a closed lower end 110b, and a cylindrical outer wall 110c extending upward from lower end 110b to upper end 110a. Thus, vessel 110 has an elongate, vertically oriented inner chamber or cavity 111 extending from open upper end 110a to closed lower end 110b. Cavity 111 may be described as having a bottom 112 defined by the closed lower end 110b of vessel 110. Inner cavity 111 has a height H₁₁₁ and a width W₁₁₁. In this embodiment, vessel 110 and cavity 111 are generally cylindrical, and thus, the width W₁₁₁ is uniform along the height H₁₁₁ and is equal to the diameter of cavity 111 (inner diameter of vessel 110). For testing in a lab environment, cavity 111 preferably has a height H₁₁₁ less than 48.0 in., and more preferably, between about 18.0 in. and 36.0 in.; and a width W₁₁₁ between about 2.0 in. and 10.0 in., and more preferably between 4.0 in. and 8.0 in. Although vessel 110 and cavity 111 are cylindrical in this embodiment, and thus, have circular cross-sections, in general, vessel 110 and cavity 111 can have other cross-sectional geometries such as rectangular, triangular, etc. In this embodiment, vessel 110 is transparent (e.g., glass, clear polymer, or the like) such that the slurry within inner cavity 111 can be viewed visually through vessel 110.

Pressure transducers 120 are uniformly vertically spaced along vessel 110 and fixably attached to outer wall 110c. Pressure transducers 120 are arranged to measure the hydrostatic pressure of the fluid (e.g., a slurry) within cavity 111 at particular locations, and communicate the measured hydrostatic pressures to computer device 150. In particular, a lower pressure transducer 120 measures the hydrostatic pressure in cavity 111 at the bottom 112, an upper pressure transducer 120 measures the hydrostatic pressure in cavity 111 between ends 110a, 110b, and an intermediate pressure transducer 120 measures the hydrostatic pressure in cavity 111 between the upper pressure transducer 120 and the lower pressure transducer 120. For purposes of clarity and further explanation, the lower pressure transducer 120 is also denoted with reference numeral 120a, the intermediate pressure transducer 120 is also denoted with reference numeral 120b, and the upper pressure transducer 120 is also denoted with reference numeral 120c. Although three pressure transducers 120a, 120b, 120c are provided in this embodiment, in general, any number of pressure transducers (e.g., pressure transducers 120) can be provided with the understanding at least one pressure transducer (e.g., pressure transducer 120a) is positioned to measure the hydrostatic pressure within the inner cavity of the test vessel (e.g., cavity 111 of test vessel 110) at the bottom of the inner cavity (e.g., bottom 112).

As is known in the art, hydrostatic pressure is the pressure (gauge) exerted by a fluid at equilibrium at a given point within the fluid due to the force of gravity (e.g., the weight of the column of fluid extending vertically upward from the given point), and can be calculated as follows:

P=ρ·g·h (eq. 1)

where, P is the hydrostatic pressure of the fluid (e.g., N/m², lbf/ft², or psi)

ρ is the density of the fluid (e.g., kg/m³, Ibₘ/ft³, or Ibₘ/in³)

g is the acceleration of gravity (e.g., 9.81 m/s², 32.17 ft/s², or 386.04 in/s²)

note: for mixed phase fluids such as a slurry including proppant and liquid, ρ is the average density of the column of fluid extending vertically upward from the given point

Each pressure transducer 120 is configured to accurately measure the hydrostatic pressure within cavity 111 to the nearest 0.001 psi. For most slurries, the anticipated hydrostatic pressures within cavity 111 will be between 0.0 psig and about 5.0 psig, and more specifically, between 0.0 psig and about 2.0 psig. Thus, each transducer 120 preferably has a pressure measurement range from 0.0 psig to about 5.0 psig, and more specifically, from 0.0 psig to about 2.0 psig. It should be appreciated that the desired sensitivity and accuracy of the pressure transducers (e.g., pressure transducers 120a, 120b, 120c) will depend, at least in part, on the height of the test cavity (e.g., height H₁₁₁ of cavity 111). The preferred sensitivities and accuracies of pressure transducers described above are generally suitable for test cavities sized for use in a lab environment (e.g., vessel 110 having a cavity 111 with a height H₁₁₁ less than 48.0 in.). However, in other embodiments that may not be sized for use in a lab environment (e.g., a cavity 111 with a height H₁₁₁ on the order of tens or hundreds of feet), the preferred accuracies and sensitivities of the pressure transducers may vary.

Each transducer 120 preferably communicates hydrostatic pressure measurements to the computing device 150 at a frequency of at least 0.5 Hertz (every 2 seconds), and more preferably of at least 1.0 Hertz (every second). In general, each pressure transducer 120 can be any suitable pressure transducer capable of measuring a fluid pressure (gauge) between 0.0 psig and 50 psig to the nearest 0.001 psig. One example of a suitable pressure transducer is the Custom Configured Pressure Transducer available from OMEGA Engineering, Inc. of Norwalk, Conn., USA.

Referring still to FIG. 5, in this embodiment, computing device 150 includes a processor 151 (e.g., microprocessor, central processing unit, or collection of such processor devices, etc.), one or more input interface(s) 152 (e.g., keyboard, mouse, etc.), one or more output interface(s) 153 (e.g., monitor), and memory 154. Processor 151, interface(s) 152, 153, and memory 154 are coupled to a system BUS that allows the transmission of electronic signals therebetween. Interfaces 152 allow a user of computing device 150 to enter data into computing device 150 and receive pressure measurements from pressure transducers 120. Processor 151 executes machine-readable instructions (e.g., software) provided on memory 154. Memory 154 can store input data and the results of processing executed by processor 151, as well as store the computer instructions to be executed by processor 151. Memory 154 may comprise volatile storage (e.g., random access memory), non-volatile storage (e.g., flash storage, read only memory, etc.), or combinations of both volatile and non-volatile storage. Data consumed or produced by the machine-readable instructions can also be stored on memory 154. The machine readable instructions may comprise non-transitory computer readable medium.

As will be described in more detail below, to determine the quantity of proppant that settles from a slurry and the rate at which the proppant settles, pressure transducer 120a periodically obtains measurements of the hydrostatic pressure of the slurry within cavity 111 at the bottom 112, and communicates the hydrostatic pressure measurements to computing device 150 via an input interface 152. The hydrostatic pressure measurements input data is stored in memory 154. In addition, a user or operator evaluating the slurry inputs the dimensions of the cavity 111 (e.g., the height H₁₁₁ and the width W₁₁₁), the physical properties of the proppant in the slurry being evaluated (e.g., density and volume), and the physical properties of the liquid in the slurry (e.g., density and volume) (collectively, the foregoing referred to as “physical parameters”) into computing device 150 via an input interface 152. The physical parameters input by the user are stored in memory 154. Using the hydrostatic pressure measurements and physical parameters stored in memory 154, processor 151 determines (e.g., calculates) the height and quantity of the proppant that has settled out of the liquid in the slurry as a function of time, which can then be used by processor 151 to determine (e.g., calculate) the rate at which the proppant settles out of the liquid in the slurry (e.g., lbs/min) and the percentage (e.g., wt %) of the proppant that settles out of the liquid as a function of time (% wt/min).

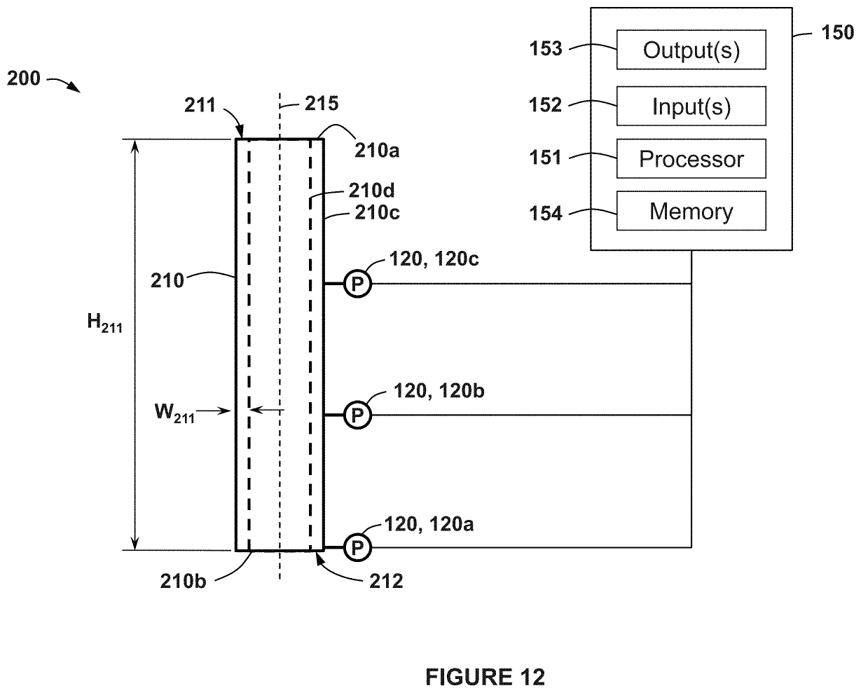

In the embodiment of vessel 110 shown in FIG. 5, vessel 110 and cavity 111 are cylindrical, and thus, cavity 111 has circular cross-sections taken in any plane oriented perpendicular to axis 115. However, in other embodiments, the vessel (e.g., vessel 110) and cavity (e.g., cavity 111) can have other shapes and cross-sectional geometries such as rectangular, triangular, etc. For example, referring briefly to FIG. 12, an embodiment of a test apparatus 200 for determining the quantity and rate at which a proppant settles out of a slurry is shown. Test apparatus 200 is the same as test apparatus 100 with the exception that vessel 210 of test apparatus 200 has a different geometry than vessel 110 previously described. More specifically, in this embodiment, test vessel 210 has a vertically oriented central or longitudinal axis 215, an open upper end 210a and a closed lower end 210b. In addition, test vessel 210 includes a radially outer cylindrical wall 210c and a radially inner cylindrical wall 210d disposed within an coaxially aligned with outer cylindrical wall 210c. Each wall 210c, 210d extend upward from lower end 210b to upper end 210a. Thus, vessel 210 comprises nested cylinders. An elongate, vertically oriented annular chamber or cavity 211 is radially positioned between walls 210c, 210d and extends from open upper end 210a to closed lower end 210b. Cavity 211 has a bottom 212 defined by the closed lower end 210b of vessel 210. Inner cavity 211 has a height H₂₁₁ and a radial width W₂₁₁ measured radially between walls 210c, 210d. In this embodiment, walls 210c, 210d are generally cylindrical, and thus, the width W₂₁₁ is uniform along the height H₂₁₁ and is equal to the difference between the outer diameter of wall 210d and the inner diameter of wall 210d. For testing in a lab environment, cavity 211 preferably has a height H₂₁₁ less than 48.0 in., and more preferably, between about 18.0 in. and 36.0 in.; and a width W₂₁₁ between about 0.5 in. and 3.0 in., and more preferably between 1.0 in. and 2.0 in. In this embodiment, the height H₂₁₁ is 28.0 in. and the width W₂₁₁ is 1.125 in. In general, test apparatus 200 operates in the same manner as test apparatus 100 previously described with the exception that annular cavity 211 is filled with the slurry 30.

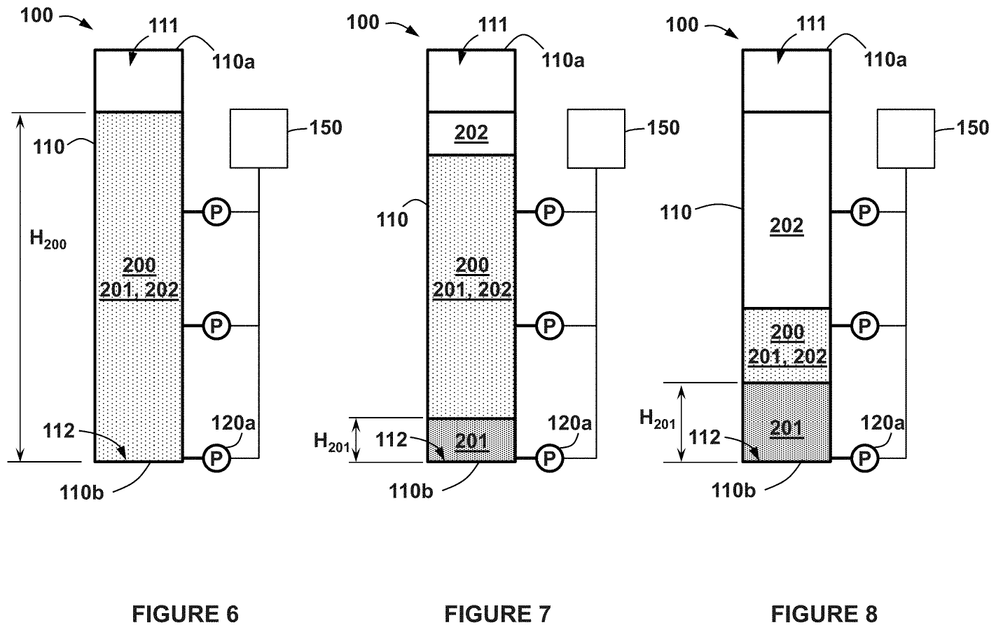

An exemplary evaluation of a slurry 200 using test apparatus 100 is shown in FIGS. 6-8 and will now be described. Slurry 200 comprises a proppant 201 mixed with a liquid 202. In general, proppant 201 can include any one or more proppant(s) known in the art as previously described including, without limitation, sand, treated sand, man-made ceramic material, or combinations thereof; and liquid 202 can be any one or more sand control liquid(s) known in the art as previously described including, without limitation, a polymer gel, a viscoelastic surfactant, Xanthan, brine, a cross-linked borate fluid, cross-linked gel, diesel, oil, foam, or combinations thereof.

In FIG. 6, slurry 200 is shown thoroughly mixed within vessel 110. In FIG. 7, slurry 200 is shown after being left alone for a period of time during which some of the proppant 201 has settled out of the liquid 202, and thus, a portion of the proppant 201 is settled at the bottom 112 of cavity 111 and seated against the lower end 110b of vessel 110. In FIG. 8, slurry is shown after being left alone for yet another period of time during which more of the proppant 201 has settled out of the liquid 200, and thus, a greater portion of the proppant 201 is disposed at the bottom 112 of cavity 111 and seated against the lower end 110b of vessel 110. Thus, FIGS. 6-8 illustrate sequential schematic illustrations of slurry 200 disposed in vessel 100 after a first period of time (moving from FIG. 6 to FIG. 7) and a second period of time (moving from FIG. 7 to FIG. 8). In FIGS. 7 and 8, the proppant 201 that has settled out of the liquid 202 has a height H₂₀₁ measured vertically from the bottom 112 of cavity 111. As illustrated by the increase in the height H₂₀₁ moving from FIG. 7 to FIG. 8, over time, more proppant 201 settles out of the liquid 202.

The proppant 201 in the slurry 200 has a predetermined and known composition, density, and total weight; and the liquid 202 in the slurry 200 has a predetermined and known composition, density, and total weight. For example, the density of the proppant 201 and the density of the liquid 202 can be determined from the respective compositions, and the total weights of the proppant 201 and the liquid 202 can be determined prior to mixing them together to form slurry 200. It should be appreciated that the volume of the proppant 201 and the volume of the liquid 202 can be determined from the respective weights and densities.

Referring now to FIG. 6, proppant 201 and liquid 202 are mixed together to form slurry 200, which is placed in vessel 110. The slurry 200 has a total height H₂₀₀ in vessel 110 (within cavity 111) that remains constant during testing since proppant 201 and liquid 202 are incompressible, and further, proppant 201 and liquid 202 do not chemically react or combine. Thus, proppant 201 and liquid 202 remain distinct and separate, each maintaining its physical properties, despite being mixed together. It should be appreciated that the total weight of the slurry 200 can be determined (e.g., calculated) by a variety of techniques known in the art including, without limitation: (i) adding the weight of the proppant 201 and the weight of the liquid 202; or (ii) subtracting the empty weight of vessel 110 from the weight of vessel 110 with slurry 200 therein. In addition, the total volume of the slurry 200 can be determined by a variety of techniques known in the art including, without limitation: (i) adding the predetermined volume of the proppant 201 and the volume of the liquid 202; (ii) measuring the height of the slurry 200 in cavity 111, and then multiplying the measured height by the cross-sectional area of cavity 111 (e.g., A=πr² for a cylindrical cavity 111); or (iii) by using graduated markings on the vessel 110 (if available).

As shown in FIG. 6, the proppant 201 and liquid 202 are sufficiently mixed such that, at least initially, the proppant 201 is uniformly distributed throughout the liquid 202 (e.g., the concentration of the proppant 201 is substantially the same throughout the liquid 202). Assuming a uniform distribution of proppant 201 in liquid 202, the slurry 200 has a uniform density throughout, which can be determined by dividing the total mass of the slurry 200 (based on the total weight of the slurry 200) by the total volume of the slurry 200. The calculated density of the slurry 200 when the uniformly mixed can be used to calibrate and/or test pressure transducer 120a. In particular, the hydrostatic pressure at the lower end 110b of vessel 110 measured with pressure transducer 120a can be compared to the hydrostatic pressure calculated as described above (based on the height H₂₀₀, the density of the slurry 200, and the force of gravity). The measured hydrostatic pressure and the calculated hydrostatic pressure should be equal (or substantially equal). If the measured hydrostatic pressure and the calculated hydrostatic pressure are not equal (or substantially equal), adjustments can be made to transducer 120a or the measured hydrostatic pressures output by transducer 120a to account for any differences

Referring still to FIG. 6, once slurry 200 is placed in vessel 110, each transducer 120a, 120b, 120c measures the hydrostatic pressure in the vessel 110 at its respective position and communicates the measured hydrostatic pressure to computing device 150. In general, each transducer 120a, 120b, 120c can measure and communicate the corresponding hydrostatic pressure in vessel 110 continuously or periodically. In embodiments described herein, each transducers 120a, 120b, 120c preferably measures and communicates the corresponding hydrostatic pressure in vessel 110 at least once every 2.0 s (0.5 Hz frequency), and more preferably at least once every 1 s (1.0 Hz frequency).

Referring now to FIGS. 6-8, over time, proppant 201 begins to settle out of liquid 202 under the force of gravity and fall toward the bottom 112 of cavity 111. Thus, as shown in FIG. 7, after a period of time, a portion of proppant 201 falls to the bottom 112 of cavity 111 and sits on the lower end 110b of vessel 110. The proppant 201 that settles at the bottom 112 has a height H₂₀₁ as described above. Assuming (a) the proppant 201 seated on the lower end 110b of vessel 110 and the proppant 201 supported (directly or indirectly) by the proppant 201 seated on the lower end 110b of vessel 110 (as opposed to proppant 201 suspended within liquid 202) no longer contributes to the weight or density of the slurry 200 extending vertically from transducer 120a to height H₂₀₀, (b) the weight and density of the liquid 202 contributing to the weight and density of the slurry 200 extending vertically from transducer 120a to height H₂₀₀ is constant over time (e.g., does not change); (c) the volume of the slurry 200 in vessel 110 is constant over time (e.g., does not change); and (d) the height H₂₀₀ of the slurry 200 in vessel 110 is constant over time (e.g., does not change), then changes in the hydrostatic pressure measured by transducer 120a result exclusively from changes in the amount of proppant 201 that is suspended in the slurry 200 and changes in the amount of proppant 201 that has settled out of liquid 202 in the slurry 200. In particular, the proppant 201 that settles out of the liquid 202 no longer contributes to the average density of the slurry 200 or the hydrostatic pressure measured by transducer 120a. Such assumptions and phenomena can be used to determine (e.g., calculate) the quantity (e.g., mass) of proppant 201 that has settled out of the liquid as a function of time. More specifically, at any given time, the hydrostatic pressure measured by transducer 120a can be used to determine (e.g., calculate) the height of the proppant 201 that settles out of the liquid 202. One exemplary solution for determining (via calculation) the height of solid particles (e.g., proppant 201) that has settled out of a liquid (e.g., liquid 202) at the bottom of a cavity (e.g., bottom 112 of cavity 111), where the solid particles are mixed with the liquid in a slurry or two-phase mixture, is as follows:

$$D = \frac{[ ( P * {V}_{h} ) - ( h * {V}_{h} * {ρ}_{f} ) + ( {W}_{p} * {A}_{v} * {ρ}_{f} ) - {W}_{p} ]}{[ ( {V}_{h} * {ρ}_{b} * {A}_{v} * {ρ}_{f} ) - ( {V}_{h} * {ρ}_{f} ) - ( {V}_{h} * {ρ}_{b} ) + ( {V}_{h} * {ρ}_{f} ) ]} \qquad ( eq . 2 )$$

where:
D is the height of the settled solid particles (e.g., the height H₂₀₁ of the settled proppant 201);
P is the hydrostatic pressure measured at the bottom of the cavity within which the slurry is placed (e.g., bottom 112 of cavity 111);
Vₕ is the volume per unit height of the cavity;
h is the total height of the slurry in the cavity (e.g., the height H₂₀₀ of slurry 200 in cavity 111);
ρ_{f} is the density of the liquid in the slurry (e.g., the density of liquid 202);
Wₚ is the total weight of the solid particles in the slurry (e.g., the total weight of proppant 201 in the slurry 200);
Aᵥ is the absolute volume of the solid particles in the slurry (e.g., the absolute volume of proppant 201); and
ρ_{b} is the bulk density of the solid particles in the slurry (e.g., the bulk density of proppant 201).

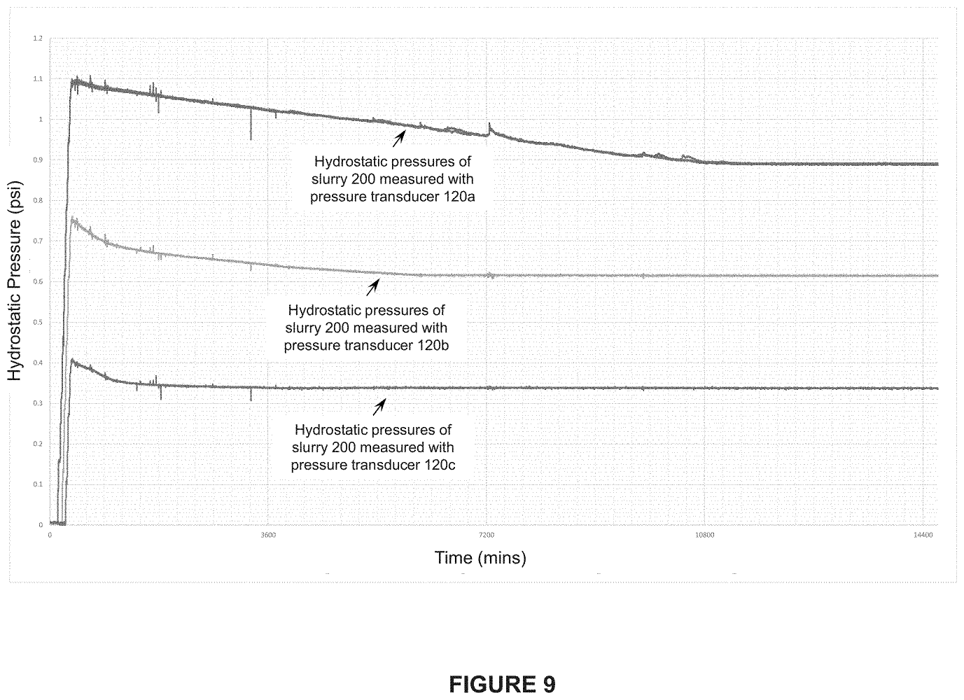

The height of the settled solid particles (D) can then be used to determine the percentage of the total solid particles that have settled. By tracking these parameters as a function of time, the percentage of the solid particles that settles over time, which indicates the rate at which the solid particles settle, is determined. For example, FIG. 9 illustrates hydrostatic pressure measurements of an exemplary slurry 200 taken by transducers 120a, 120b, 120c as a function of time using an embodiment of a test apparatus 200 as previously described and shown in FIG. 12. In the embodiment of test apparatus 200 used to conduct generate the hydrostatic pressure measurements shown in FIG. 9, the height H₂₁₁ of annular cavity 211 was 28.0 in. and the radial width W₂₁₁ of cavity 211 was 1.125 in., and each pressure transducer 120a, 120b, 120c measured and communicated the hydrostatic pressure of slurry 200 within cavity 211 at a frequency of_1.0 Hz (once every second).

As shown in FIG. 9, and as expected due to differences in the heights of the columns of the slurry 200 measured vertically from each pressure transducer 120a, 120b, 120c, the hydrostatic pressure measured by transducer 120a at any given time was greater than the hydrostatic pressure measured by transducer 120b at the same time, and the hydrostatic pressure measured by transducer 120b at any given time was greater than the hydrostatic pressure measured by transducer 120c at that time. In addition, as shown in FIG. 9, the hydrostatic pressure measured by each pressure transducer 120a, 120b, 120c generally decreased over time as the proppant 201 settled out of the liquid 202. After all of the proppant 201 had settled out of the portion of liquid 202 positioned above a given transducer 120a, 120b, 120c, the hydrostatic pressure measured by that particular transducer 120a, 120b, 120c was substantially constant.

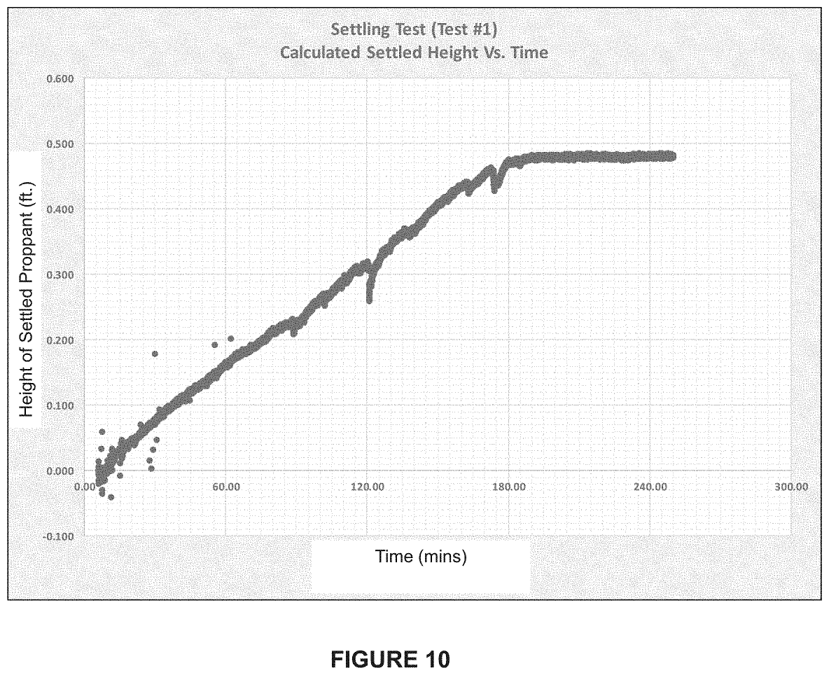

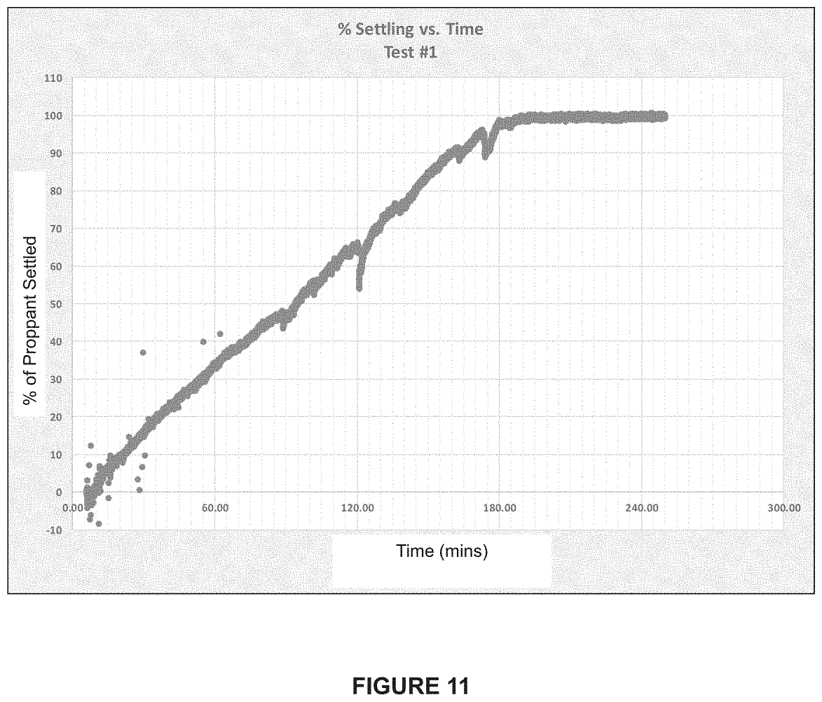

Using the hydrostatic pressure measurements of pressure transducer 120a from FIG. 9, the height of the proppant 201 that settled from the liquid 202 (e.g., D in eq. 2 above) was determined with computing device 150 as a function of time and is shown in FIG. 10. Next, the quantity (e.g., mass) of proppant 201 that settled from the liquid 201 was determined as a function of time and used to determine the percentage of the proppant 201 that settled from the liquid as a function of time as shown in FIG. 11.

In the manner described, embodiments of test apparatuses disclosed herein (e.g., test apparatuses 100, 200) can be used to determine the quantity of proppant (e.g., proppant 201) and percentage of proppant that settles from the liquid (e.g., liquid 202) of a slurry (e.g., slurry 200) over time by using the hydrostatic pressure of the slurry measured with a pressure transducer (e.g., pressure transducer 120a) at the bottom of a cavity within which the slurry is placed (e.g., the bottom 112 of cavity 111). Without being limited by this or any particular theory, such techniques disclosed herein for determining the quantity and rate at which proppant settles from the liquid of a slurry are more accurate than conventional techniques that rely on visually estimating the settling quantity of a proppant. It should be appreciated that the hydrostatic pressure measurements of the slurry 200 at the bottom 112 of cavity 111 from pressure transducer 120a can be used to determine the quantity and rate at which proppant 201 settles from the liquid 202 of slurry 200, and thus, hydrostatic pressure measurements from the remaining transducers 120b, 120c are not necessary to determine the quantity and rate at which proppant 201 settles from the liquid 202 of slurry 200. However, hydrostatic pressure measurements from pressure transducers 120b, 120c may be beneficial in assessing or studying a variety of other factors including, without limitation, the settling rates in different vertical sections of the slurry 200 in cavity 111, proppant 201 particle-to-particle interactions within liquid 202.

Although embodiments disclosed herein are described in the context of proppant settling from liquid in slurries for installing gravel packs, it should be appreciated that embodiments of systems and methods described herein can also be used to estimate the settling quantity and rate of any solid particulate matter disposed in a fluid (e.g., liquid or gas). For instance, embodiments of systems and methods described above can be used to determine the height of the solid particles that settle from the liquid, which in turn can be used to determine the quantity of the solid particles that settles from the liquid as a function of time, as well as the rate at which the solid particles settle from the liquid as a function of time.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A method for determining a rate at which solid particles settle from a liquid in a slurry, the method comprising:
(a) mixing the solid particles and the liquid to form the slurry;
(b) placing the slurry in an inner cavity of a vessel;
(c) measuring a hydrostatic pressure of the slurry at a bottom of the inner cavity over a period of time after (b); and
(d) determining a quantity of the solid particles that settle from the liquid as a function of time over the period of time using the hydrostatic pressure measurements from (c).

2. The method of claim 1, wherein (a) comprises mixing the solid particles throughout the liquid such that a concentration of the proppant throughout the liquid is substantially uniform.

3. The method of claim 1, wherein (c) comprises measuring the hydrostatic pressure of the slurry at the bottom of the inner cavity at a frequency of at least_0.5 Hz; and
wherein (d) comprises determining the quantity of the solid particles that settles from the liquid between each pair of sequential hydrostatic pressure measurements from (c) over the period of time.

4. The method of claim 1, wherein (c) comprises communicating each hydrostatic pressure measurement to a computing device; and
wherein (d) comprises calculating the quantity of the solid particles that settle from the liquid as a function of time over the period of time with the computing device.

5. The method of claim 1, wherein the solid particles comprise a proppant including a sand, a treated sand, a ceramic material, or combinations thereof; and
wherein the liquid of the slurry comprises a polymer gel, a viscoelastic surfactant, Xanthan, a brine, a cross-linked borate fluid, a cross-linked gel, diesel, an oil, a foam, or combinations thereof.

6. The method of claim 1, wherein the hydrostatic pressure of the slurry at the bottom of the inner cavity is measured with a first pressure transducer coupled to the vessel.

7. The method of claim 6, wherein the measured hydrostatic pressures are between 0.0 and 2.0 psi, and wherein the first pressure transducer measures the hydrostatic pressures to the nearest 0.001 psi during the period of time.

8. The method of claim 1, wherein (d) comprises:
(d1) calculating a height of the solid particles that settles from the liquid in the inner cavity using the hydrostatic pressure measurements from (c); and
(d2) calculating the quantity of the solid particles that settle from the liquid as a function of time over the period of time using the calculated heights from (d1).

9. An apparatus for determining a settling rate of solid particles mixed with a liquid in a slurry, the apparatus comprising:
a vessel having an inner cavity configured to receive and hold the slurry, wherein the inner cavity has a bottom; and
a first pressure transducer coupled to the vessel and configured to measure a hydrostatic pressure of the slurry in the inner cavity at a first location adjacent the bottom of the inner cavity.

10. The apparatus of claim 9, wherein the first pressure transducer is configured to measure the hydrostatic pressure of the slurry at a frequency of at least 0.5 Hz.

11. The apparatus of claim 10, wherein the first pressure transducer is configured to measure the hydrostatic pressure between 0.0 and 5.0 psi to the nearest 0.001 psi.

12. The apparatus of claim 9, wherein the inner cavity has a height H measured vertically from the bottom, wherein the height H is less than 48.0 in.

13. The apparatus of claim 9, wherein the solid particles of the slurry comprises a proppant, wherein the proppant comprises sand, a treated sand, a ceramic material, or combinations thereof.

14. The apparatus of claim 13, wherein the liquid of the slurry comprises a polymer gel, a viscoelastic surfactant, Xantham, a brine, a cross-linked borate fluid, a cross-linked gel, diesel, an oil, a foam, or combinations thereof.

15. The apparatus of claim 9, wherein the first pressure transducer is coupled to a sidewall of the vessel, wherein the sidewall extends vertically from a lower end of the vessel adjacent the bottom of the inner cavity to an upper end of the vessel.

16. The apparatus of claim 15, further comprising a second pressure transducer coupled to the sidewall of the vessel and vertically positioned above the first pressure transducer, wherein the second pressure transducer is configured to measure the hydrostatic pressure of the slurry in the inner cavity at a second location vertically spaced above the first location.

17. The apparatus of claim 15, wherein the second pressure transducer is configured to measure the hydrostatic pressure of the slurry at the location at a frequency of at least 0.5 Hz.

18. The apparatus of claim 16, wherein the second pressure transducer is configured to measure the hydrostatic pressure between 0.0 and 5.0 psi to the nearest 0.001 psi.

19. The apparatus of claim 9, further comprising a computing device coupled to the first pressure transducer and configured to receive and record the hydrostatic pressure measurements from the first pressure transducer.

20. The apparatus of claim 19, wherein the computing device is configured to determine a quantity of the solid particles that settles from the slurry as a function of time.
